(19) United States
(12) Patent Application Publication
(10) Pub. No.: US 2008/0072414 A1
(43) Pub. Date: Mar. 27, 2008

(54) Concrete reinforcing guide and method of constructing concrete reinforcing guide

(76) Inventor: Gloria Marie Buley, Shokan, NY (US)

Correspondence Address: MCANDREWS HELD & MALLOY, LTD, 500 WEST MADISON STREET, SUITE 3400, CHICAGO, IL, 60661, US

(21) Appl. No.: 11/521,002

(22) Filed: Sep. 14, 2006

(51) Int. Cl. B28B 3/00; B23P 17/00; B23P 11/00

(52) U.S. Cl. 29/527.1; 264/333; 29/428

(57) ABSTRACT

Certain embodiments of the present technology provide reinforcing guide systems used in fabrication of concrete elements and methods of constructing reinforcing guides used in fabrication of concrete elements. For example, in one embodiment, a reinforcing guide system used in fabrication of a concrete element comprises: a guide; and a plurality of brackets attached to the guide, wherein each bracket is configured to receive and secure a reinforced bar. For example, in one embodiment, a method of fabricating a concrete element comprises: providing a guide with a plurality of brackets attached thereto; securing a plurality of reinforced bars to the guide using the brackets, thereby constructing a reinforcing guide; placing the reinforcing guide in a mold; and pouring mixed concrete into the mold.

### BACKGROUND OF THE INVENTION

Embodiments of the present technology generally relate to fabrication of concrete elements that include reinforcing guides. More particularly, embodiments of the present technology relate to reinforcing guide systems used in fabrication of concrete elements and methods of constructing reinforcing guides used in fabrication of concrete elements.

Concrete is a building material made from the combination of aggregate and a cement binder. A common form of concrete consists of Portland cement, mineral aggregates (for example, gravel and sand) and water. After mixing, the water reacts with the cement in a chemical process known as hydration, during which the water is absorbed by the cement, which hardens, binding the aggregates together and eventually creating a stone-like material. Concrete is used, for example, in pavement, building structures, foundations, roads, and bases for gates, fences and poles. Concrete is also used, for example, in concrete columns used in construction known as footings.

Concrete has high compressive strength, but low tensile strength. In other words, concrete can withstand axially directed pushing forces, but cannot withstand axially directed pulling forces. As a result, concrete elements subjected to tensile stresses are often reinforced with steel bars, known as rebar, which can aid in carrying tensile loads. Rebar is often formed from mild steel, and given ridges for better frictional adhesion to the concrete.

In practice, a reinforcing guide, also referred to as a reinforcing cage, can be constructed out of rebar. A reinforcing guide can be constructed out of multiple pieces of rebar that are maintained relative to each other in conjunction with specific design requirements. Some examples of items that can influence the design requirements of a reinforcing guide include: the type of structure that is being fabricated, the size and weight of the structure, and the bearing capacity of the soil upon which the structure will rest.

Once a reinforcing guide is constructed, it can be inserted into a mold that can receive concrete. In one example, a mold can be a tube made of cardboard or other fibrous material. Examples of such tubes are the Sonotube® made by Sonoco Products Company and the Quik-tube® made by the QUIKRETE® Companies.

Once a reinforcing guide is constructed and inserted into a mold, mixed concrete can be poured into the tube and allowed to harden. The result is a concrete element that includes a reinforcing guide that, as described above, can aid in carrying tensile loads.

Unfortunately, constructing a reinforcing guide can be time-consuming and cumbersome. For example, one method used to construct reinforcing guides utilizes pieces of wire to connect pieces of rebar in a desired configuration. However, one problem with such a method is that the resulting reinforcing guide is not very durable and can fall apart or lose desired dimensions when being moved or inserted into a mold. In another example, pieces of rebar that make up a reinforcing guide can be welded together. Such reinforcing guides are more durable than the ones held together by wires, however, they can be costly in terms of materials and labor.

Thus, there is a need for new reinforcing guide systems used in fabrication of concrete elements and new methods of constructing reinforcing guides used in fabrication of concrete elements that can reduce the amount of time that is required to construct a reinforcing guide and/or can result in a durable reinforcing guide.

### BRIEF SUMMARY OF THE INVENTION

Certain embodiments of the present technology provide reinforcing guide systems used in fabrication of concrete elements and methods of constructing reinforcing guides used in fabrication of concrete elements.

For example, in one embodiment, a reinforcing guide system used in fabrication of a concrete element comprises: a guide; and a plurality of brackets attached to the guide, wherein each bracket is configured to secure a reinforced bar. For example, in one embodiment, a bracket used in a reinforcing guide system comprises: a threaded bolt; and a sleeve with an opening therethrogh configured to receive a reinforced bar and a hole therein configured to receive the threaded bolt; and the bracket is configured to secure a reinforced bar between the threaded bolt and the sleeve by screwing the threaded bolt through the hole until the reinforced bar is secured between the threaded bolt and the sleeve. For example, in one embodiment, a bracket used in a reinforcing guide system comprises a c-clamp that is configured to secure a reinforced bar between a threaded element and a side of the c-clamp. For example, in one embodiment, a bracket used in a reinforcing guide system comprises a tension sleeve with a perforation that runs the length of the tension sleeve, and the bracket is configured such that a reinforced bar can be secured by pressing the reinforced bar through the perforation in the tension sleeve.

For example, in one embodiment, a method of constructing a reinforcing guide used in fabrication of a concrete element comprises: providing a guide with a plurality of brackets attached thereto; and securing a plurality of reinforced bars to the guide using the brackets. For example, in one embodiment, securing a plurality of reinforced bars to the guide using the brackets comprises: passing a reinforced bar through a sleeve that is attached to the first reinforced bar; and screwing a threaded bolt through a hole in the sleeve until the reinforced bar is secured between the threaded bolt and the sleeve. For example, in one embodiment, securing a plurality of reinforced bars to the guide using the brackets comprises: placing a reinforced bar in a c-clamp that is attached to the guide; and screwing a threaded element toward a side of the c-clamp until the reinforced bar is secured between the threaded element and the side of the c-clamp. For example, in one embodiment, securing a plurality of reinforced bars to the guide using the brackets comprises passing a reinforced bar through a perforation in a tension sleeve that is attached to the guide.

For example, in one embodiment, a method of fabricating a concrete element comprises: providing a guide with a plurality of brackets attached thereto; securing a plurality of reinforced bars to the guide using the brackets, thereby constructing a reinforcing guide; placing the reinforcing guide in a mold; and pouring mixed concrete into the mold.

### BRIEF DESCRIPTION OF THE DRAWINGS

FIG. 1 illustrates a perspective view of a concrete element fabrication system used in accordance with an embodiment of the present technology.

FIG. 2 illustrates a top view of a concrete element fabrication system used in accordance with an embodiment of the present technology.

FIG. 3 illustrates a side view of a section of a reinforcing guide used in accordance with an embodiment of the present technology.

FIG. 4 illustrates a method of fabricating a concrete element that includes a reinforcing guide used in accordance with an embodiment of the present technology.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

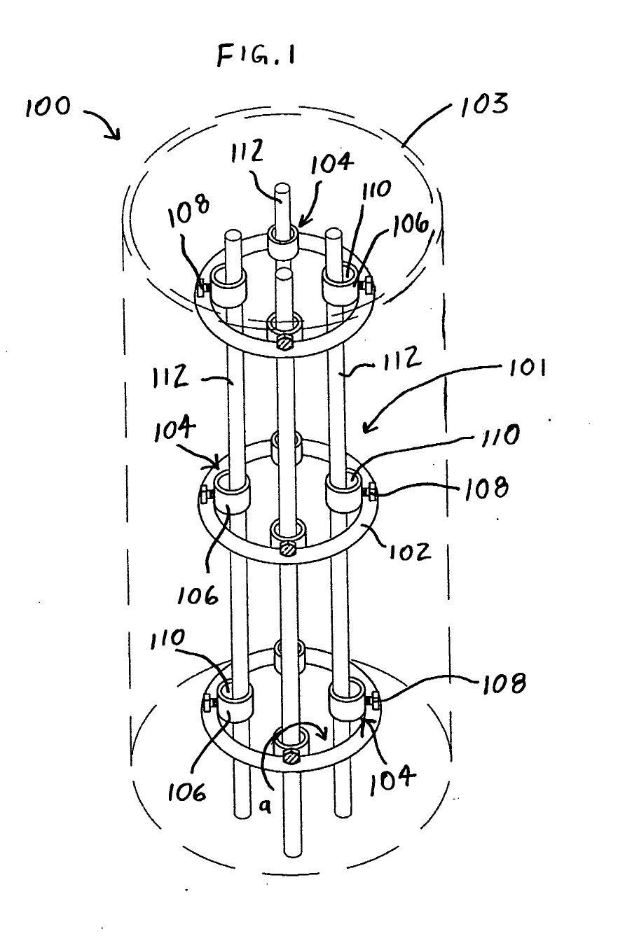

FIG. 1 illustrates a perspective view of a concrete element fabrication system 100 used in accordance with an embodiment of the present technology. In the embodiment shown in FIG. 1, the concrete element fabrication system 100 includes a reinforcing guide 101 and a mold 103. The reinforcing guide 101 includes a guide 102 and brackets 104. Each bracket 104 includes a sleeve 106 and a threaded bolt 108. Each sleeve 106 is attached to the guide 102. Each sleeve 106 has an opening 110 therethrough configured to receive a reinforced bar 112. Each sleeve 106 has a hole therein (not shown) configured to receive a threaded bolt 108.

In operation, a reinforcing guide 101 such as the one depicted in FIG. 1, for example, can be constructed by securing a reinforced bar 112 to a guide 102 with brackets 104 as follows. First, a reinforced bar 112 can be passed through the opening 110 of a sleeve 106 and positioned as desired. Then, a threaded bolt 108 can be screwed through a hole in the sleeve 106 by rotating the bolt 108 in a direction a, such that the threaded end (not shown) of the bolt 108 passes through the hole in the sleeve 106. The threaded bolt 108 can be screwed through the hole until it contacts the reinforced bar 112, thereby securing the reinforced bar 112 between the bolt 108 and the sleeve 106.

Likewise, a reinforcing guide 101 such as the one depicted in FIG. 1, can be de-constructed and/or re-configured by unsecuring a reinforced bar 112 from a guide 102. For example, in the embodiment shown in FIG. 1, the reinforced bar 112 can be unsecured from the guide 102 by rotating the bolt 108 in a direction opposite to direction a, thereby unscrewing the bolt 108 from the hole in the sleeve 106. Once the bolt is sufficiently unscrewed from the hole in the sleeve 106, such that the reinforced bar 112 is no longer secured, the reinforced bar 112 can be repositioned or removed from the opening 110 of the sleeve 106.

After a first bracket 104 is used to secure a first reinforced bar 112 to a guide 102, a second bracket 104 can be used to secure a second reinforced bar 112 to the guide 102, and so on, until each bracket 104 that is attached to the guide 102 is being used to secure a reinforced bar 112 to the guide 102.

After a first guide 102 is secured to a reinforced bar 112, another guide 102 can be secured to the reinforced bar 112, and so on, until the desired number of guides 102 are secured to the reinforced bar 112.

Once a reinforcing guide 101 is constructed, it can be placed in a mold 103. The mold 103 can then be filled with mixed concrete. After the concrete sets, the mold 103 can be removed and a concrete element that contains a reinforcing guide can remain.

In the embodiment shown in FIG. 1, three guides 102 are shown secured to four reinforced bars 112. However, in other embodiments, the number and spacing of guides and reinforced bars can vary depending on the design requirements of the reinforcing guide and/or local building codes.

In the embodiment shown in FIG. 1, the guide 102 is made of reinforced bar. In other embodiments, a guide may not be made of reinforced bar. For example, in other embodiments, a guide can be made of any material that is sufficiently strong and durable to be used in a reinforcing guide.

In the embodiment shown in FIG. 1, the guide 102 is circular in shape. In other embodiments, a guide may not be circular. For example, in other embodiments, a guide can be square, triangular, rectangular, trapezoidal, or any other type of shape. For example, in other embodiments, a guide can be a straight element or an element with any number of bends or curves. For example, in other embodiments, the shape of the guide can vary depending on the design requirements of the reinforcing guide.

In the embodiment shown in FIG. 1, the guide 102 is sized to be placed within a tube-shaped mold 103. In one embodiment, a guide may be sized to be placed in a tube-shaped mold that has a diameter of ten inches. In another embodiment, a guide may be sized to be placed in a tube-shaped mold that has a diameter of twelve inches. In other embodiments, a guide may be sized to be placed in a tube-shaped mold that has a different diameter. For example, in other embodiments, the size of the guide can vary depending on the design requirements of the reinforcing guide and/or local building codes that govern minimum concrete fill space.

In the embodiment shown in FIG. 1, there are four brackets 104 attached to each guide 102. In other embodiments, there may not be four brackets attached to each guide. For example, in other embodiments, a guide can have 2, 3, 5, 6, 7, 8 or any other number of brackets attached thereto. For example, in other embodiments, the number of brackets attached to a guide can vary depending on the design requirements of the reinforcing guide.

In the embodiment shown in FIG. 1, the brackets 104 are spaced equidistant from each other around the inner edge of the guide 112. In other embodiments, the brackets 104 may not be spaced equidistant from each other around the inner edge of the guide 112. For example, in other embodiments, the spacing of brackets and/or the placement of brackets on the inner or outer edge of a guide may vary depending on the design requirements of the reinforcing guide.

In the embodiment shown in FIG. 1, each bracket 104 is configured to accommodate a reinforced bar. In one embodiment, each bracket may be configured to accommodate a reinforced bar that is: a 1/2 inch in diameter (such as #4 rebar, for example), 5/8 of an inch in diameter (such as #5 rebar, for example), and/or 3/4 of an inch in diameter (such as #6 rebar, for example). In other embodiments, brackets may be configured to accommodate reinforced bars of different sizes.

In the embodiment shown in FIG. 1, each bracket includes a sleeve 106 and a threaded bolt 108. In other embodiments, a bracket can comprise a c-clamp that is configured to secure a reinforced bar between a threaded element and a side of the c-clamp. In other embodiments, a bracket can comprise a tension sleeve with a perforation that runs the length of the tension sleeve, and the bracket can be configured such that a reinforced bar can be secured to a guide by pressing the reinforced bar through the perforation in the tension sleeve.

In the embodiment shown in FIG. 1, each bracket 104 is welded to the guide 102. In other embodiments, brackets may not be welded to a guide. For example, in other embodiments, brackets can be clipped onto a guide using a tension sleeve with a perforation. In such embodiments, the tension sleeve can be pressed onto the guide such that the bracket is secured onto the guide after the guide passes through the perforation. For example, in other embodiments, the guide and brackets can be a single element. For example, in such embodiments, the guide and brackets can be cast as a single piece.

In the embodiment shown in FIG. 1, the mold 103 is tube-shaped. In other embodiments, a mold may not be tube-shaped. For example, in other embodiments, a mold can be square, triangular, rectangular, trapezoidal, or any other type of shape. For example, in other embodiments, the shape of the mold can vary depending on the design requirements of the concrete element.

In the embodiment shown in FIG. 1, the mold 103 is made of cardboard. In other embodiments, a mold may not be made of cardboard. For example, in other embodiments, a mold can be made of wood and/or other materials. For example, in other embodiments, the material the mold is made of can vary depending on the design requirements of the concrete element.

A tube-shaped mold made of cardboard, such as the one described in connection with FIG. 1, for example, can be used in construction to create columns that are known as footings. Footings can require reinforcing guides, such as those described in connection with FIG. 1, for example. Footings can vary in size and structural requirements and so can the design requirements of reinforcing guides used in their fabrication.

As noted above, alternative embodiments may vary depending on the design requirements of a reinforcing guide and/or a concrete element. Some examples of items that can influence the design requirements of a reinforcing guide and/or a concrete element include: the type of structure that is being fabricated, the size, weight and shape of the structure, and the bearing capacity of the soil upon which the structure will rest.

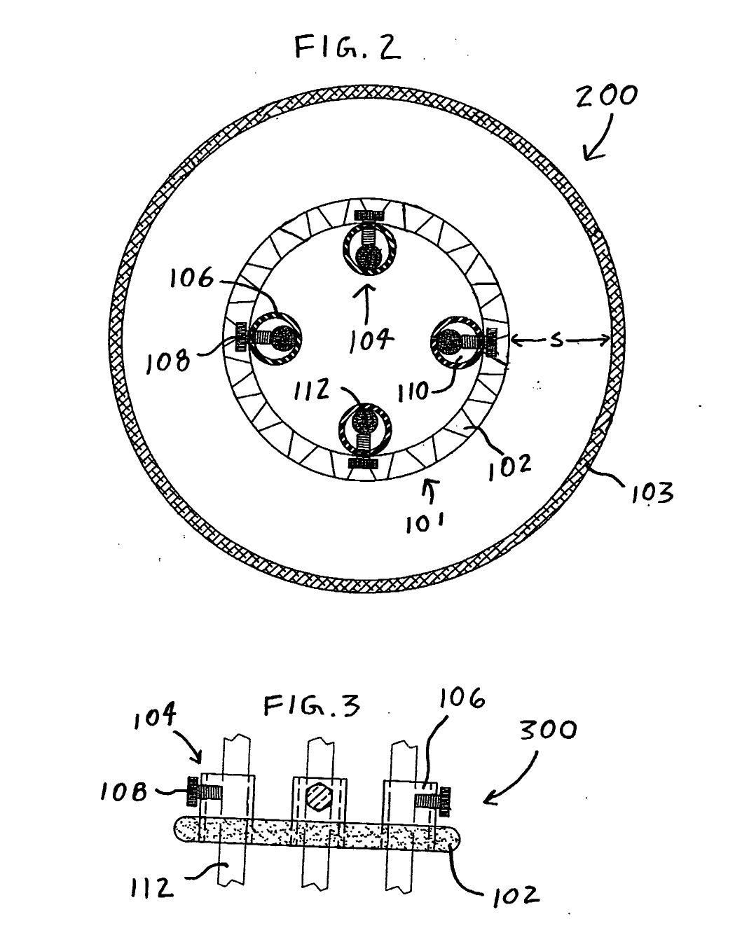

FIG. 2 illustrates a top view of a concrete element fabrication system 200 used in accordance with an embodiment of the present technology. The system 200 includes elements that are the same as elements shown and described in connection with FIG. 1. Elements shown in FIG. 2 that are the same as elements shown and described in connection with FIG. 1 are identified with the same numbers used in connection with FIG. 1, and can have embodiments (shown and alternative) that are similar to those described in connection with FIG. 1, for example.

In the embodiment shown in FIG. 2, the concrete element fabrication system 200 includes a reinforcing guide 101 and a mold 103. The reinforcing guide 101 includes a guide 102 and brackets 104. Each bracket 104 includes a sleeve 106 and a threaded bolt 108. Each sleeve 106 is attached to the guide 102. Each sleeve 106 has an opening 110 therethrough configured to receive a reinforced bar 112. Each sleeve 106 has a hole therein (not shown) configured to receive a threaded bolt 108. As shown in the embodiment shown in FIG. 2, each threaded bolt 108 is in contact with a reinforced bar 112 that is also in contact with a sleeve 106. Each reinforced bar 112 is thereby secured to the guide 102 by a bracket 104.

In the embodiment shown in FIG. 2, the reinforcing guide 101 is centered within a mold 103 such that there is a space s between the outer edge of the guide 102 and the inner edge of the mold 103. In one embodiment, the spacing between the outer edge of a guide and the inner edge of a mold can be two inches. In other embodiments, the spacing between the outer edge of a guide and the inner edge of a mold may not be two inches. For example, in other embodiments, the spacing between the outer edge of a guide and the inner edge of a mold can vary depending on the design requirements of the concrete element and/or local building codes.

FIG. 3 illustrates a side view of a section of a reinforcing guide 300 used in accordance with an embodiment of the present technology. The reinforcing guide 300 includes elements that are the same as elements shown and described in connection with FIG. 1. Elements shown in FIG. 3 that are the same as elements shown and described in connection with FIG. 1 are identified with the same numbers used in connection with FIG. 1, and can have embodiments (shown and alternative) that are similar to those described in connection with FIG. 1, for example.

In the embodiment shown in FIG. 3, the reinforcing guide 300 includes a guide 102 and brackets 104. In the embodiment shown in FIG. 3, each bracket 104 includes a sleeve 106 and a threaded bolt 108. Each sleeve 106 is attached to the guide 102. Each sleeve 106 has an opening 110 therethrough configured to receive a reinforced bar 112. Each sleeve 106 has a hole therein (not shown) configured to receive a threaded bolt 108. As shown in the embodiment shown in FIG. 3, each threaded bolt 108 is in contact with a reinforced bar 112 that is also in contact with a sleeve 106. Each reinforced bar 112 is thereby secured to the guide 102 by a bracket 104.

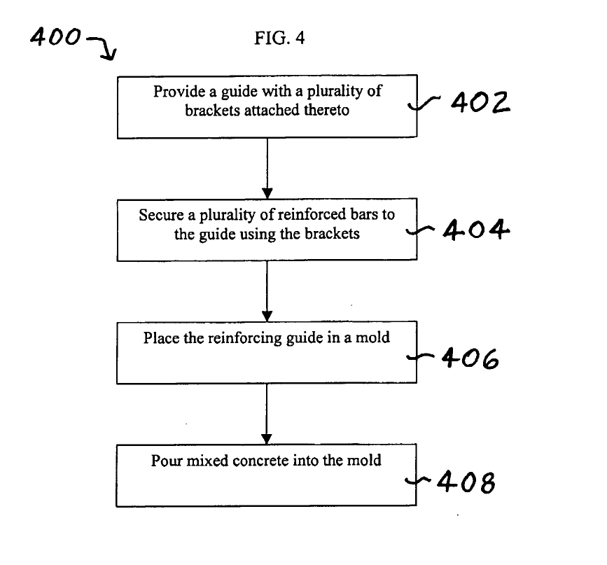

FIG. 4 illustrates a method 400 of fabricating a concrete element that includes a reinforcing guide. At 402, a guide with a plurality of brackets attached thereto is provided. At 404, a plurality of reinforced bars are secured to the guide using the brackets, thereby constructing a reinforcing guide. At 406, the reinforcing guide is placed in a mold. At 408, mixed concrete is poured into the mold. In application, applying the method 400 as described above, and/or in light of the embodiments described in connection with FIGS. 1-3, can reduce the amount of time that is required to construct a reinforcing guide used in fabrication of a concrete element, and thereby reduce the amount of time required to fabricate the concrete element. Also, applying the method 400 as described above, and/or in light of the embodiments described in connection with FIGS. 1-3, can result in a durable reinforcing guide for use in fabrication of a concrete element, and thereby result in a quality concrete element.

While the invention has been described with reference to embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A reinforcing guide system used in fabrication of a concrete element comprising:
a guide; and
a plurality of brackets attached to the guide, wherein each bracket is configured to secure a reinforced bar.

2. The system of claim 1, wherein a bracket comprises:
a threaded bolt; and
a sleeve with an opening therethrogh configured to receive a reinforced bar and a hole therein configured to receive the threaded bolt; and
wherein the bracket is configured to secure a reinforced bar between the threaded bolt and the sleeve by screwing the threaded bolt through the hole until the reinforced bar is secured between the threaded bolt and the sleeve.

3. The system of claim 1, wherein a bracket comprises a c-clarnp that is configured to secure a reinforced bar between a threaded element and a side of the c-clamp.

4. The system of claim 1, wherein a bracket comprises a tension sleeve with a perforation that runs the length of the tension sleeve, and wherein the bracket is configured such that a reinforced bar can be secured by pressing the reinforced bar through the perforation in the tension sleeve.

5. The system of claim 1, wherein a bracket is welded to the guide.

6. The system of claim 1, wherein a bracket and the guide are a single element.

7. The system of claim 6, wherein the single element is formed by casting.

8. The system of claim 1, wherein a bracket is permanently attached to the guide.

9. The system of claim 1, wherein a bracket is removably attached to the guide.

10. The system of claim 1, wherein the guide is circular in shape.

11. The system of claim 1, wherein the guide is rectangular in shape.

12. The system of claim 1, wherein the guide is a straight element.

13. The system of claim 1, wherein a bracket is configured to receive a reinforced bar that is at least one of the following diameters: 1/2 an inch, 5/8 of an inch and 3/4 of an inch.

14. A method of constructing a reinforcing guide used in fabrication of a concrete element, the method comprising:
providing a guide with a plurality of brackets attached thereto; and
securing a plurality of reinforced bars to the guide using the brackets.

15. The method of claim 14, wherein securing a reinforced bar to the guide comprises:
passing a reinforced bar through a sleeve that is attached to the guide; and
screwing a threaded bolt through a hole in the sleeve until the reinforced bar is secured between the threaded bolt and the sleeve.

16. The method of claim 14, wherein securing a reinforced bar to the guide comprises:
placing a reinforced bar in a c-clamp that is attached to the guide; and
screwing a threaded element toward a side of the c-clamp until the reinforced bar is secured between the threaded element and the side of the c-clamp.

17. The method of claim 14, wherein securing a reinforced bar to the guide comprises pressing a reinforced bar through a perforation in a tension sleeve that is attached to the guide.

18. A method of fabricating a concrete element, the method comprising:
providing a guide with a plurality of brackets attached thereto;
securing a plurality of reinforced bars to the guide using the brackets, thereby constructing a reinforcing guide;
placing the reinforcing guide in a mold; and
pouring mixed concrete into the mold.

19. The method of claim 18, wherein the mold is a tube.

20. The method of claim 18, wherein the mold is for a footing.
